(19) United States
(12) Patent Application Publication
(10) Pub. No.: US 2013/0088976 A1
(43) Pub. Date: Apr. 11, 2013

(54) Method for Detecting Mismatch Fault and Maintenance Endpoint

(71) Applicants: Ting Ao, Shenzhen (CN); Yuehua Wei, Shenzhen (CN); Shaoyong Wu, Shenzhen (CN)

(72) Inventors: Ting Ao, Shenzhen (CN); Yuehua Wei, Shenzhen (CN); Shaoyong Wu, Shenzhen (CN)

(73) Assignee: ZTE CORPORATION, Shenzhen, Guangdong (CN)

(21) Appl. No.: 13/805,812

(22) PCT Filed: Dec. 15, 2010
(86) PCT No.: PCT/CN10/79829

§ 371 Date: Dec. 20, 2012

(30) Foreign Application Priority Data
Jun. 21, 2010 (CN) 201010205896.9

(51) Int. Cl. H04L 12/26

(52) U.S. Cl. CPC H04L 43/0823
USPC 370/242

(57) ABSTRACT

The disclosure provides a method for detecting a mismatch fault and a Maintenance Endpoint (MEP). The method includes: determining whether there is a Traffic Engineering Service Instance (TESI) configured in a segment, setting a Present Traffic in Segment (PTS) variable, and setting a value of a PTS field included in a Connectivity Check Message (CCM) sent from a Maintenance Endpoint (MEP); receiving the CCM by the MEP, when the value of the PTS field included in the CCM does not coincide with that of the PTS variable, setting, by the MEP, a first mismatch fault indication variable mmCCMreceived to be set; when the first mismatch fault indication variable mmCCMreceived remains set after a first preset time period expires, detecting that a mismatch fault occurs. The method finds timely the mismatch problem occurred in the segment protection of Provider Backbone Bridging-Traffic Engineering (PBB-TE), thereby preventing data loss and service interruption caused by the occurrence of mismatch.

### TECHNICAL FIELD

The disclosure relates to the Ethernet protection technology, and particularly to a method for detecting a mismatch fault and a Maintenance Endpoint (MEP) in the segment protection technology of Provider Backbone Bridging-Traffic Engineering (PBB-TE).

### BACKGROUND

With the introduction of carrier Ethernet concept, for making the Ethernet meet the telecommunication grade standard, higher demand of protection and switching of the Ethernet is proposed. In the existing protection switching technology of PBB-TE, protection to a Traffic Engineering Service Instance (TESI), namely an end-to-end tunnel protection, is supported currently. The end-to-end tunnel protection solution not only takes longer protection switching time, but also involves too many nodes, which cannot realize protection to its intermediate link and node. Once a certain intermediate link or node is failed, it is necessary to switch the whole TESI; besides, if there are multiple TESIs on the failed link or failed node, switching of multiple TESIs is caused. That is to say, the protected object of the end-to-end protection solution in the PBB-TE is the TESI; when it is detected that a certain working TESI is failed, it is needed to use another protection TESI to encapsulate user message entering the PBB-TE tunnel again, so that the traffic is forwarded through the protection PBB-TE tunnel.

For the Ethernet, protection to link and node is one part of the Ethernet protection; most network faults occur on a certain link or node, so the segment protection of PBB-TE becomes more urgent; many operators have made requirements for the segment protection of PBB-TE, that is, specially configuring a protection segment on a working segment of the PBB-TE tunnel to protect the working segment, wherein the working segment and the protection segment compose an Infrastructure Protection Group (IPG).

FIG. 1 shows a schematic diagram of the current segment protection of PBB-TE; as shown in FIG. 1, an IPG includes one working segment and one or more protection segments. When there is no fault detected on the working segment, all traffics protected by the IPG of PBB-TE are forwarded from the working segment normally; once there is fault occurring on the working segment or related management instruction is received, and a Segment Edge Bridge (SEB) of the IPG of PBB-TE can timely detect the fault, the SEB will switch traffic, namely triggering a Forwarding Database (FDB) to update, and modifying an egress port of the FDB to which the TESI protected by the IPG corresponds into an egress port to which the protection segment corresponds on the SEB (i.e. a TESI mapping process), thereby switching traffic to the protection segment, realizing protection to the working segment, ensuring normal forwarding of the network traffic and improving the reliability of network.

FIG. 2 shows a schematic diagram of a current working segment and protection segment of PBB-TE; in FIG. 2, a grid with grid shades represents a Segment Endpoint Port (SEP), and a grid with oblique lines shade represents a Segment Intermediate Port is (SIP). In the existing segment protection of PBB-TE, a member segment means the working segment or the protection segment of an IPG. The working segment means the one by which the traffic passes in normal operation; as shown in FIG. 2, the protection segment means the one which includes the traffic after switching because of detecting a fault on the working segment or receiving a management instruction of switching; as shown in FIG. 2, the segment means a series of LAN and MAC relay composition between a PNP port and a PNP port; as shown in FIG. 2, the SEB is used for ending two ends of segment, and it may be either a BEB device or a BCB device in the PBB-TE network; as shown in FIG. 2, a bridge device in middle of segment is the SIB, and the SIB may be the BCB device; as shown in FIG. 2, the IPG traffic switching means redirecting a group of TESI protected by the IPG from the working segment to the protection segment, or from the protection segment to the working segment, wherein the redirection is usually implemented by modifying the egress port of corresponding item to which the TESI corresponds in the FDB.

FIG. 3 shows a schematic diagram of the current segment connectivity detection of PBB-TE; in FIG. 3, a grid with snowflake shadows represents the PNP port, a blank grid represents the PNP or CBP port. As shown in FIG. 3, the connectivity detection of middle segment of PBB-TE includes: configuring a TESI, which is a channel for forwarding a Connectivity Check Message (CCM), on the segment. A point-to-point Maintenance Association (MA) is initiated on the TESI, and two endpoints SEP of the segment are down MEP of the MA. The connectivity of the segment is detected by sending the CCM to each other.

Sometimes, when some devices are failed or configured wrongly, the problem of mismatch may occur when the SEBs at two ends map the TESI to the right segment. For maintaining the normal operation of network, it is needed to recognize the problem of mismatch and report the mismatch. There are usually two kinds of mismatch: one is caused by incomplete switching of segment protection, and the other is caused by working/protection configuration fault.

For the mismatch caused by incomplete switching of segment protection, for example, fault of device, although the local device detects the fault, it has failed to realize is switching, and the local device sends the CCM including a Remote Defect Indication (RDI) field to the remote SEB, so the remote device maps the TESI to the protection segment, and the local device still transmits traffic on the working segment. Similarly, the mismatch will occur in the event that the local device has mapped the TESI to the protection segment, but the remote device has failed to map the TESI to the protection segment when receiving the CCM including the RDI field which is set as well.

The working/protection configuration fault will occur in the event of mismatch. For example, one end is configured as transmitting the traffic on the working segment, and the other end is configured as transmitting the traffic on the protection segment. Or, when one end is configured as reversing mode and the other end is configured as non-reversing mode, when the fault disappears, the problem of mismatch will occur as well.

For preventing data loss and service interruption caused by the occurrence of mismatch, it is necessary to be able to detect mismatch fault and report the fault. At present, there is no solution for implementing detection for mismatch fault.

### SUMMARY

In view of the above, the disclosure mainly aims to provide a method for detecting a mismatch fault and an MEP, which can find timely the mismatch problem occurred in the segment protection of PBB-TE, thereby preventing data loss and service interruption caused by the occurrence of mismatch.

For achieving above aim, the following technical solutions are provided.

A method for detecting a mismatch fault is provided includes:

determining whether there is a Traffic Engineering Service Instance (TESI) configured in a segment, setting a Present Traffic in Segment (PTS) variable, and setting a value of a PTS field included in a Connectivity Check Message (CCM) sent from a Maintenance Endpoint (MEP);

receiving the CCM by the MEP, when the value of the PTS field included in the CCM does not coincide with that of the PTS variable, setting, by the MEP, a first mismatch fault indication variable mmCCMreceived to be set; and

when the first mismatch fault indication variable mmCCMreceived remains set after a first preset time period expires, detecting that a mismatch fault occurs.

When determining whether there is a TESI configured in a segment, the setting a PTS variable may include:

finding out egress port values of the TESI protected by an Infrastructure Protection Group (IPG) in a Forwarding Database (FDB); and setting the PTS variable of the MEP to which the egress port corresponds in the IPG as true or 1.

The value of the PTS field included in the CCM may be: setting the value of the PTS field (traffic) in the CCM according to a value of the PTS variable of the MEP.

The value of the PTS field of the CCM may be equal to the value of the PTS variable of the MEP.

The method may further include: when the MEP detects that a fault occurs in the segment where the MEP itself is,

sending, by the MEP, a CCM including a Remote Defect Indication (RDI) flag, and setting a value of an RDI variable presentRDI of the MEP as true;

when both the value of the variable presentRDI and the value of the PTS variable are true, setting, by the MEP, a second mismatch fault indication variable presentmmloc to be set; and

when the second mismatch fault indication variable presentmmloc remains set after a second preset time period expires, detecting that a mismatch fault occurs; otherwise, detecting that operation is normal and no mismatch fault occurs.

The TESI may be a TESI traffic or a TESI tunnel protected by the IPG where the MEP is.

A method for detecting a mismatch fault includes:

determining whether there is a Traffic Engineering Service Instance (TESI) configured in a segment, setting a Present Traffic in Segment (PTS) variable;

when a Maintenance Endpoint (MEP) detects that a fault occurs in the segment is where the MEP itself is,

setting, by the MEP, a value of a Remote Defect Indication (RDI) variable presentRDI as true;

when both the value of the variable presentRDI and a value of the PTS variable are true, setting, by the MEP, a second mismatch fault indication variable presentmmloc to be set; and

when the second mismatch fault indication variable presentmmloc remains set after a second preset time period expires, detecting that a mismatch fault occurs.

When determining whether there is a TESI configured in a segment, the setting a PTS variable may include: finding out egress port values of the TESI protected by an Infrastructure Protection Group (IPG) in a Forwarding Database (FDB); and setting the PTS variable of the MEP to which the egress port corresponds in the IPG as true or 1.

The setting a value of an RDI variable presentRDI by the MEP may include: when detecting that a fault occurs in the segment, sending, by the MEP, a Connectivity Check Message (CCM) including an RDI flag which is set, and setting the value of the RDI variable presentRDI of the MEP as true.

The TESI may be a TESI traffic or a TESI tunnel protected by the IPG where the MEP is.

A Maintenance Endpoint (MEP) includes: the MEP is configured to determine that there is a Traffic Engineering Service Instance (TESI) configured in a segment to which itself corresponds, and set a value of a Present Traffic in Segment (PTS) variable of the MEP itself as true; to include a value of a PTS field in a Connectivity Check Message (CCM) sent from the MEP itself according to the value of the PTS variable; for the MEP which receives the CCM, when the value of the PTS field included in the received CCM does not coincide with that of the PTS variable set by itself, to set a first mismatch fault indication variable mmCCMreceived to be set; and

when the first mismatch fault indication variable mmCCMreceived remains set after is a first preset time period expires, the MEP may be configured to detect that a mismatch fault occurs.

The determining that there is a TESI configured in a segment to which the MEP itself corresponds and setting a PTS variable may include:

an Infrastructure Protection Group (IPG) finds out egress port values of the TESI protected by itself in the a Forwarding Database (FDB); and setting the PTS variable of the MEP to which the egress port corresponds in the IPG as true or 1.

The MEP may be further configured to, when detecting that a fault occurs in the segment where the MEP itself is, send a CCM including a Remote Defect Indication (RDI) flag, and set a value of a variable presentRDI of the current MEP as true.

The MEP may be further configured to, when both the value of the variable presentRDI and the value of the PTS variable are true, set a second mismatch fault indication variable presentmmloc to be set; and

when the second mismatch fault indication variable presentmmloc remains set after a second preset time period expires, it may be configured to detect that a mismatch fault occurs; otherwise, it may be configured to detect that operation is normal and no mismatch fault occurs.

The TESI may be a TESI traffic or a TESI tunnel protected by the IPG where the MEP is.

A Maintenance Endpoint (MEP) includes: the MEP is configured to determine that there is a Traffic Engineering Service Instance (TESI) mapped in a segment to which itself corresponds, and set a value of a Present Traffic in Segment (PTS) variable of the MEP itself as true; and to include a value of a PTS field in a Connectivity Check Message (CCM) sent from the MEP itself according to the value of the PTS variable;

when detecting that a fault occurs in the segment where the MEP itself is, the MEP is configured to send a CCM including a Remote Defect Indication (RDI) flag, and set the value of a variable presentRDI of the current MEP as true, which means that a fault of working segment is detected currently;

when both the value of its variable presentRDI and the value of the PTS variable set by itself are true, it is configured to set a second mismatch fault indication variable presentmmlo) to be set; and

when the second mismatch fault indication variable presentmmloc remains set after a second preset time period expires, it is configured to detect that a mismatch fault occurs; otherwise, it is configured to detect that operation is normal and no mismatch fault occurs.

It can be seen from above technical solutions provided by the disclosure that the MEP determines that there is a TESI mapped in a segment to which itself corresponds, sets a PTS variable, and includes the set value of a PTS field in the CCM sent from the MEP itself; the MEP receives the CCM, obtains that the value of the PTS field (traffic) included in the CCM does not coincide with that of the PTS variable set by itself through comparison, and detects that a mismatch fault occurs. When detecting that a fault occurs in the segment where the MEP itself is, the MEP sends the CCM including an RDI flag, and sets the value of an RDI variable presentRDI of the current MEP as true, for showing that the CCM sent from the MEP includes the RDI currently, and indicating the remote MEP that a fault is detected at this end; when both the value of its current presentRDI and the value of the PTS variable set by itself are true, the MEP detects that a mismatch fault occurs. The method of the disclosure finds timely the mismatch problem occurred in the segment protection of PBB-TE, thereby preventing data loss and service interruption caused by the occurrence of mismatch.

### BRIEF DESCRIPTION OF THE DRAWINGS

FIG. 1 shows a schematic diagram of the current segment protection of PBB-TE;

FIG. 2 shows a schematic diagram of a current working segment and protection segment of PBB-TE;

FIG. 3 shows a schematic diagram of the current segment connectivity detection of PBB-TE;

FIG. 4 shows a flowchart of a method for detecting a mismatch fault according to the is disclosure;

FIG. 5 shows a schematic diagram of an embodiment of PBB-TE segment composition according to the disclosure;

FIG. 6 shows a flowchart of a first embodiment of detecting a mismatch fault according to the disclosure;

FIG. 7 shows a flowchart of a second embodiment of detecting a mismatch fault according to the disclosure;

FIG. 8 shows a schematic diagram of an embodiment that a fault occurs in the PBB-TE segment in FIG. 5 according to the disclosure;

FIG. 9 shows a flowchart of a third embodiment of detecting a mismatch fault according to the disclosure; and

FIG. 10 shows a flowchart of a fourth embodiment of detecting a mismatch fault according to the disclosure.

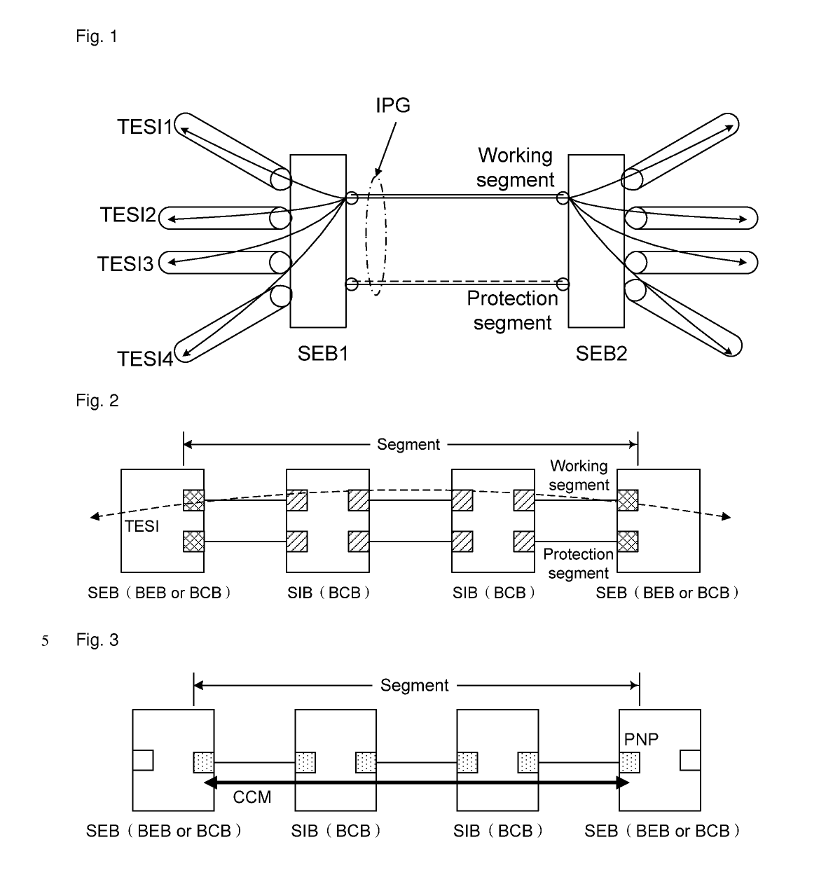

### DETAILED DESCRIPTION

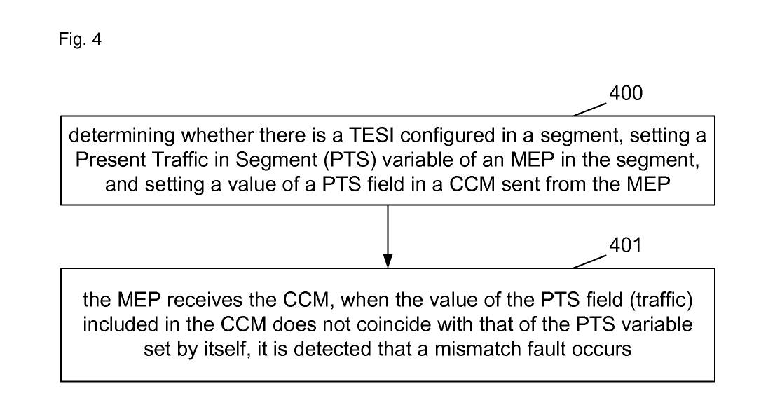

FIG. 4 shows a flowchart of a method for detecting a mismatch fault according to the disclosure; as shown in FIG. 4, the method includes the following steps.

Step 400: determining whether there is a TESI configured in a segment, setting a PTS variable of an MEP in the segment, and setting a value of a PTS field in a CCM sent from the MEP.

In the step, when it is determined that there is a TESI configured in the segment to which the MEP itself corresponds, setting the PTS as true or 1. Determining that there is a TESI configured in the segment to which the MEP itself corresponds is that: an IPG finds out egress port values of the TESI protected by it in a FDB. The PTS variable of the MEP to which the egress port corresponds in the IPG is set as true or 1; otherwise, it is set as false or 0. At this point,

the value of the PTS field (traffic) in the CCM sent from the MEP is set as the value is of the PTS variable of the MEP, that is, the MEP indicates the value of the PTS variable which is already set by it through the traffic field.

The TESI is a TESI traffic or a TESI tunnel protected by the IPG where the MEP is.

Step 401: the MEP receives the CCM, when the value of the PTS field (traffic) included in the CCM does not coincide with that of the PTS variable set by itself, it is detected that a mismatch fault occurs.

For improving the detecting accuracy of the disclosure, furthermore, in the step, after obtaining the inconsistency through comparison, setting a first mismatch fault indication variable (mmCCMreceived) to be set, namely setting it as true or 1. If the first mismatch fault indication variable (mmCCMreceived) remains set after a first preset time period expires, it is considered that the occurrence of mismatch fault is detected, and it is needed to inform the fault.

The method further includes that: when the MEP receives the CCM and obtains that the value of the PTS field included in the CCM coincides with that of the PTS variable set by itself through comparison, operation is normal, and no mismatch fault occurs.

The method further includes that: when detecting that a fault occurs in the segment where the MEP itself is, the MEP sends a CCM including an RDI flag, and sets the value of an RDI variable (presentRDI) of the MEP as true, which means that a fault of the segment which the MEP is in is detected currently, for showing that the CCM sent from the MEP includes a set RDI currently, and indicating the remote MEP that a fault is detected at this end by the local MEP. The variable presentRDI is used for showing whether a fault occurs in the segment where the MEP is currently; if the MEP obtains that both the value of the variable presentRDI and the value of the PTS variable set by itself are true, it is detected that a mismatch fault occurs; otherwise, it is detected that operation is normal, and no mismatch fault occurs. Furthermore, for improving the detecting accuracy of the disclosure, when both the value of the variable presentRDI and is the value of the PTS variable set by itself are true in the step, the following step is further included: setting a second mismatch fault indication variable (presentmmloc) to be set; if the second mismatch fault indication variable (presentmmloc) remains set after a second preset time period expires, it is considered that the occurrence of mismatch fault is detected.

Aiming at the method of the disclosure, an MEP is further provided. The MEP is configured to, when determining that there is a TESI configured in a segment, set a PTS variable of the MEP in the segment, and to include the value of a PTS field in a CCM sent from the MEP itself; when receiving the CCM, if the MEP obtains that the value of the PTS field included in the CCM does not coincide with that of the PTS variable set by itself through comparison, it is further configured to detect that a mismatch fault occurs. Furthermore, for improving the detecting accuracy of the disclosure, after obtaining the inconsistency through comparison, the MEP is further configured to set a first mismatch fault indication variable (mmCCMreceived) to be set, namely set it as true or 1. If the first mismatch fault indication variable (mmCCMreceived) remains set after a first preset time period expires, it is considered that the occurrence of mismatch fault is detected.

The MEP is further configured to, when receiving the CCM and obtaining that the value of the PTS field included in the CCM coincides with that of the PTS variable set by itself through comparison, detect that operation is normal, and no mismatch fault occurs.

When determining that there is a TESI configured in a segment, setting the value of PTS of the MEP in the segment as true or 1, and using the traffic field in the CCM sent from the MEP to include the set value of PTS;

determining that there is a TESI configured in the segment to which the MEP itself corresponds and setting the PTS of the MEP in the segment is that: an IPG finds out egress port values of the TESI protected by it in a FDB; setting the PTS variable of the MEP to which the egress port corresponds in the IPG as true or 1.

The MEP is further configured to, when detecting that a fault occurs in the segment where the MEP itself is, send a CCM including an RDI flag, and set the value of a variable presentRDI of the current MEP as true, which means that a fault of working segment is detected currently;

the MEP is further configured to receive the CCM including the RDI flag, obtain that both the value of its variable presentRDI and the value of the PTS variable set by itself are true through comparison, and detect that a mismatch fault occurs; otherwise, it is configured to detect that operation is normal, and no mismatch fault occurs.

For improving the detecting accuracy of the disclosure, when both the value of the variable presentRDI of the MEP and the value of the PTS variable set by the MEP are true, the MEP is further configured to set a second mismatch fault indication variable (presentmmloc) to be set; if the second mismatch fault indication variable (presentmmloc) remains set after a second preset time period expires, it is considered that the occurrence of mismatch fault is detected.

The method of the disclosure is described below with reference to embodiments in detail.

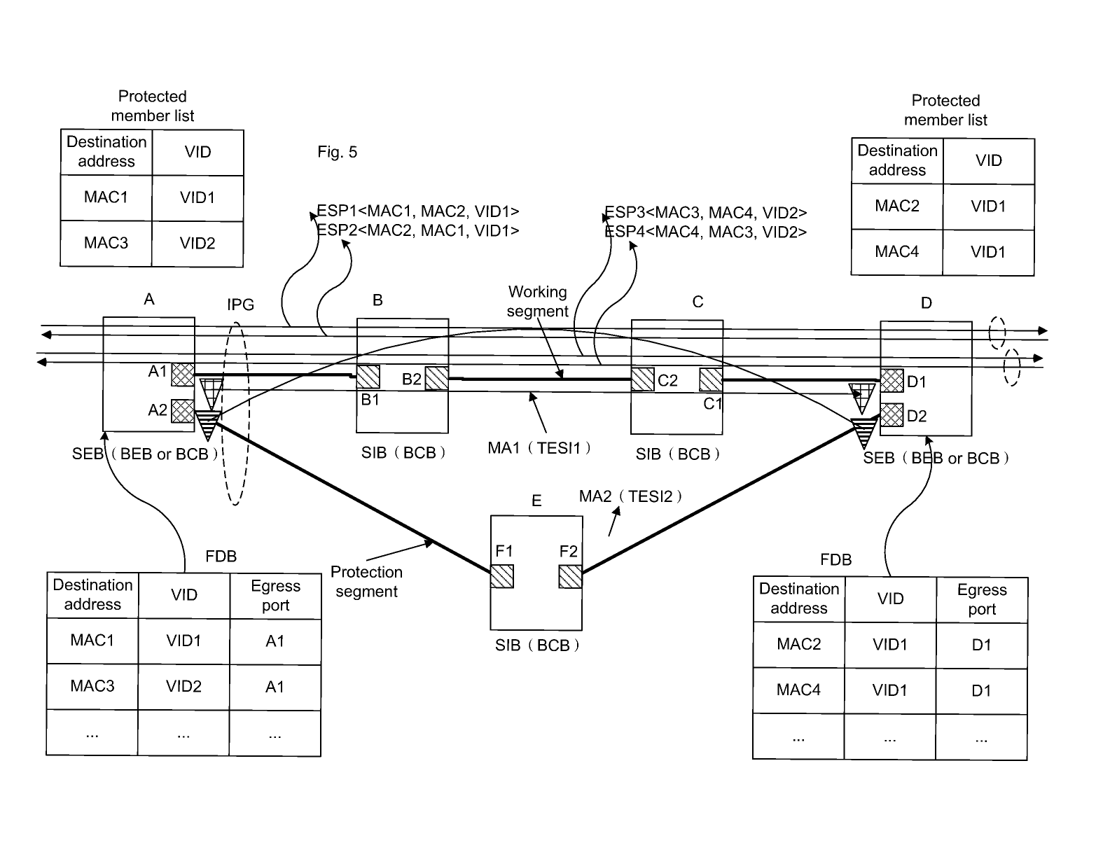

FIG. 5 shows a schematic diagram of an embodiment of PBB-TE segment composition according to the disclosure; as shown in FIG. 5, A-B-C-D is a part of PBB-TE tunnel; supposing that there are two groups of TESI passing this common path, the TESI is composed of two Ethernet Switching Paths (ESPs) in opposite directions, and each ESP is determined by a 3-tuple <ESP-DA, ESP-SA, ESP-VID>, wherein ESP-DA represents destination MAC address of the ESP, ESP-SA represents source MAC address of the ESP, and ESP-VID represents a Virtual Local Area Network Identification (VLAN ID).

The two groups of TESI are respectively expressed as: the 3-tuple to which the TESI1 corresponds is ESP1<MAC1, MAC2, VID1> and ESP2<MAC2, MAC1, VID1>; the 3-tuple to which the TESI2 corresponds is ESP3<MAC3, MAC4, VID2> and ESP4<MAC4, MAC3, VID2>.

Supposing that A-E-D is used to protect the path A-B-C-D, then A-B-C-D and A-E-D compose the IPG of the PBB-TE, wherein A-B-C-D is a working segment of the IPG, and A-E-D is a protection segment of the IPG. The protected members of the IPG include the TESI1 and the TESI2. In the normal state, a forwarding path of the TESI1 and is TESI2 is A-B-C-D. These TESIs protected by the IPG are respectively configured with a protected member list at endpoint of the IPG, as shown in FIG. 5.

A transmission channel for the CCM is configured in A-B-C-D, and the transmission channel is composed of two 3-tuples, which are respectively <MAC_{D1}, MAC_{A1}, VID3> and <MAC_{A1}, MAC_{D1}, VID3>; a maintenance united area MA1 of the segment is configured; another transmission channel for the CCM is configured in A-E-D, and the transmission channel is also composed of two 3-tuples, which are respectively <MAC_{D2},MAC_{A2},VID4> and <MAC_{A2},MAC_{D2},VID3>; a maintenance united area MA2 of the segment is configured.

In embodiments of the disclosure, supposing that Port A1 on node A and Port D1 on node D are two MEPs of the MA1; and supposing that A2 port on node A and D2 port on node D are two MEPs of the MA2. Each MEP is set with a variable PTS.

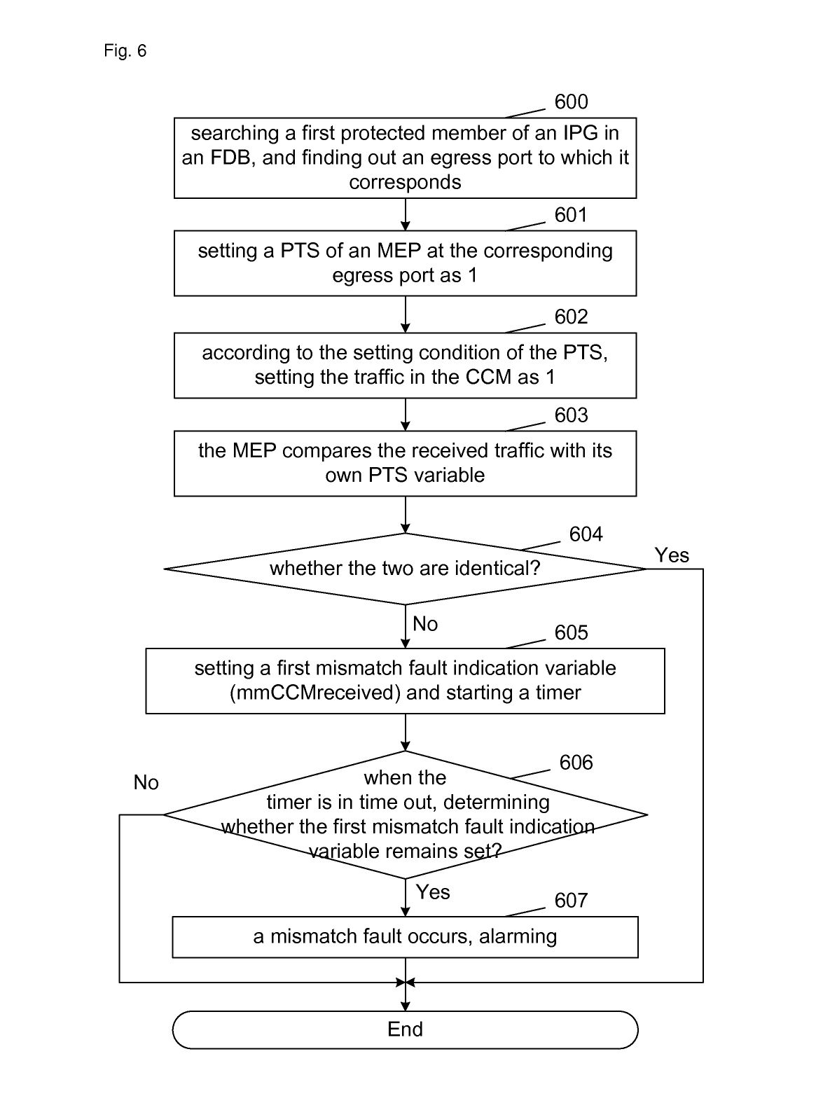

FIG. 6 shows a flowchart of a first embodiment of detecting a mismatch fault according to the disclosure; with reference to FIG. 5, in the first embodiment, supposing that determination of a PTS flag is performed only according to one of the protected members of an IPG, that is, the PTS flag of the MEP in a segment is set if it is detected that there is a member working in the segment, and supposing that an initial value of the PTS flag is 0. As shown in FIG. 6, the embodiment includes the following steps.

Step 600: searching a certain protected member list of an IPG, finding out an item to which either a first protected member or one of the protected members in the list corresponds in an FDB, and finding out an egress port to which it corresponds according to the item.

For a device A, its FDB is shown in FIG. 5, the egress port of the item to which the first protected member <MAC1, VID1> in a certain protected member list of the IPG corresponds in the FDB on the device A is port A1.

The specific implementation of the step belongs to the conventional technology of the skilled personnel in the field, so it will not be described here in detail.

Step 601: according to the found egress port, setting a PTS of an MEP to which the egress port corresponds in the IPG. Thus, corresponding to the port A1 on the is device A, the PTS variable of the MEP at the port A1 is equal to 1, which means that the traffic is transmitted through the port A1 currently; similarly, the PTS variable of the MEP at the port D1 is equal to 1.

Step 602: according to the setting condition of the PTS, a traffic field in the CCM sent from the MEP is correspondingly set.

In the first embodiment, because the PTS variable of the MEP at the port A1 on the device A is equal to 1, the traffic field in the CCM sent from the MEP at the port A1 is equal to 1. The traffic field is at the second MSB in the flag field of the CCM. Similarly, the traffic field of the CCM sent from the device D is equal to 1.

Step 603: the MEP compares the traffic field in the received CCM with its own PTS variable.

Step 604: if the two are identical, it is considered that operation is normal, and ending the flow; otherwise, entering step 605.

Step 605: setting a first mismatch fault indication variable (mmCCMreceived), namely, setting it as true or 1; at the same time, starting a timer expiring in a first time period.

Step 606: when the timer is in time out, determining whether the first mismatch fault indication variable (mmCCMreceived) remains set after the first time period expires, if so, entering step 607; otherwise, it is considered that operation is normal, and ending the flow.

Step 607: it is considered that a mismatch fault occurs, alarm information is generated to report the fault please be noted that, the specific implementation of generating alarm information to report the fault can be realized by using the existing method; it belongs to the conventional technology of the skilled personnel in the field and not intended to limit the scope of the claims of the disclosure.

Similarly, after receiving the CCM including the traffic field which is equal to 1 from the port A1, the MEP at the port D1 also compares the traffic field with its own PTS variable; if the two are identical, it is considered that traffic operates normally; if the two are different, then the device D considers that a mismatch fault occurs in the IPG, and generates alarm information to report the fault.

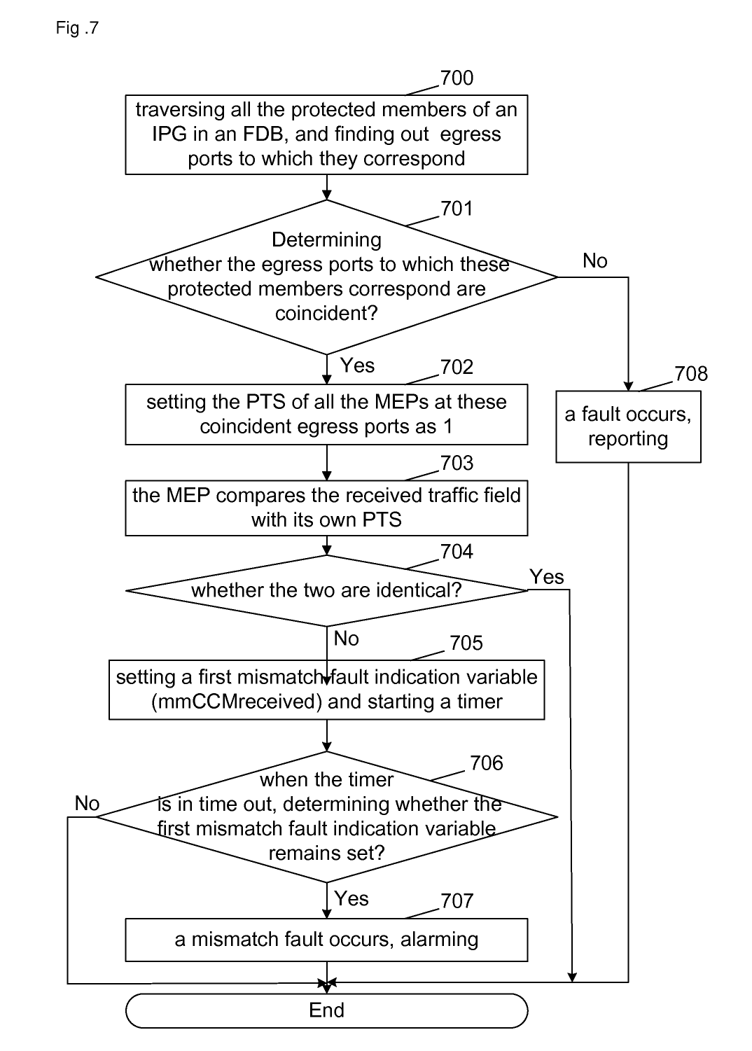

FIG. 7 shows a flowchart of a second embodiment of detecting a mismatch fault according to the disclosure; with reference to FIG. 5, in the second embodiment, supposing that determination of a PTS flag is performed according to all the protected members of an IPG, that is, it is needed to determine all the protected members; if all the protected members work in a segment, the PTS flag of the MEP in the segment is set, and supposing that an initial value of the PTS flag is 0. As shown in FIG. 7, the embodiment includes the following steps.

Step 700: searching a certain protected member list of an IPG, traversing all the protected members in the list, searching items to which these protected members correspond in an FDB, and finding out egress ports to which they correspond according to the items.

For the device A, its FDB is shown in FIG. 5; there are two protected members <MAC1, VID1> and <MAC3, VID2> in a certain protected member list of the IPG; it is obtained that both the egress ports of the two protected members are the port A1 by searching corresponding items in the FDB on the device A.

The specific implementation of the step belongs to the conventional technology of the skilled personnel in the field, so it will not be described here in detail.

Step 701: determining whether the egress ports to which these protected members correspond are coincident; if so, entering step 702; otherwise, entering step 708.

Step 702: setting the PTS of all the MEPs at these coincident egress ports.

In the second embodiment, because both the egress ports of two protected members are the port A1, which means that they are coincident, respectively setting the PTS variable of the MEPs at the ports as 1, which means that the traffic is transmitted through the port A1 currently; similarly, the PTS variable of the MEP at the port D1 is equal to 1.

According to the setting condition of the PTS, the traffic field in the CCM sent from the MEP is correspondingly set. In the second embodiment, because the PTS variable of the MEP at the port A1 on the device A is equal to 1, the traffic field in the CCM sent from the MEP at the port A1 is equal to 1. The traffic field is at the second MSB in the flag field of the CCM. Similarly, the traffic field of the CCM sent from the device D is equal to 1.

Step 703 to step 704: the MEP compares the traffic bit in the received CCM with its own PTS variable; if the two are identical, it is considered that operation is normal, and ending the flow; otherwise, entering step 705.

Step 705: setting a first mismatch fault indication variable (mmCCMreceived), namely, setting it as true or 1; at the same time, starting a timer expiring in a first time period.

Step 706: when the timer is in time out, determining whether the first mismatch fault indication variable (mmCCMreceived) remains set after the first time period expires, if so, entering step 707; otherwise, it is considered that operation is normal, and ending the flow.

Step 707: it is considered that a mismatch fault occurs, alarm information is generated to report the fault, and the flow is ended.

Step 708: reporting related information, and exiting the flow of determining mismatch.

Similarly, after receiving the CCM including the traffic which is equal to 1 from the port A1, the MEP at the port D1 compares the traffic bit with its own PTS variable; if the two are identical, it is considered that traffic operates normally; if the two are different, then the device D considers that a mismatch fault occurs in the IPG, and generates alarm information to report the fault.

The first embodiment and the second embodiment are mainly used for detecting a mismatch fault caused by working/protection configuration fault and other situations.

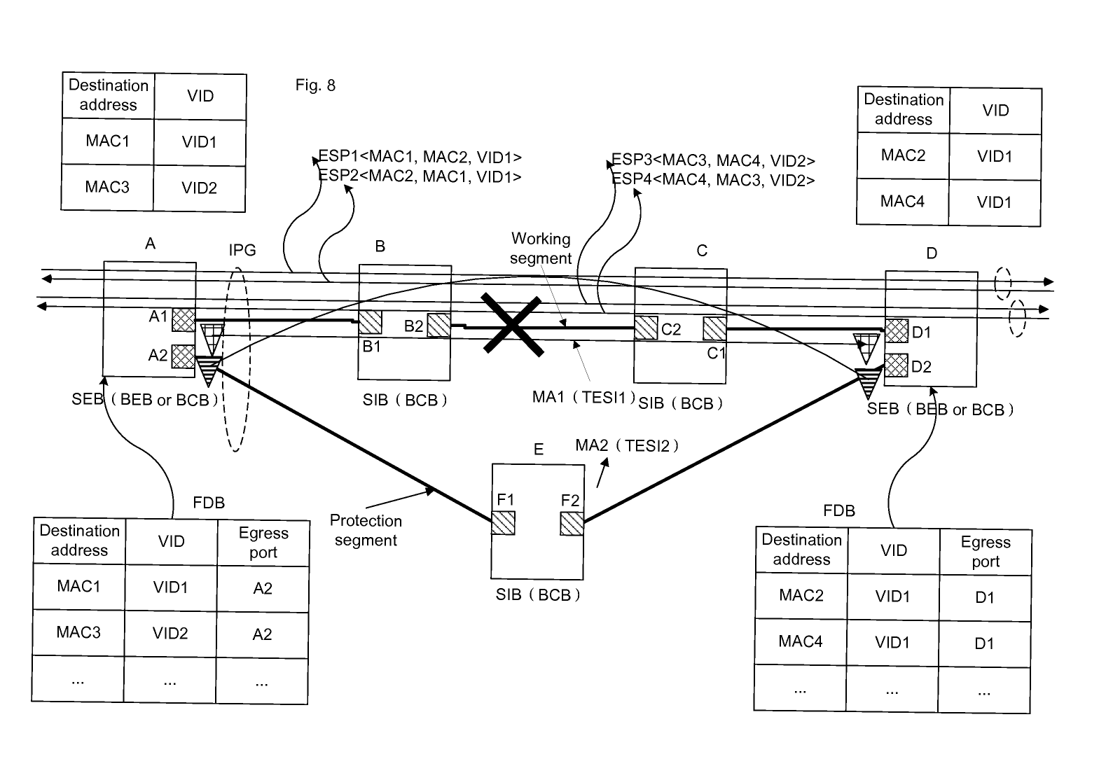

The specific implementation of detecting a mismatch fault caused by incomplete switching is described below with reference to a third embodiment and a fourth embodiment in detail. Supposing that a fault occurs in the PBB-TE segment shown in FIG. 5 for some reason, for example, part B-C, the IPG switches on the device A, but the device D does not switch; FIG. 8 shows a schematic diagram of an embodiment that a fault occurs in the PBB-TE segment in FIG. 5 according to the disclosure; as shown in FIG. 8, at this point, the egress port of the item to which the protected member of an IPG corresponds in an FDB on the device A is changed from A1 to A2, and the egress port of the item, in the FDB, to which the protected member of the IPG corresponds on the device A is still A2; however, because the device D does not switch successfully, the egress port of the item to which the protected member of the IPG corresponds in the FDB on the device D is still D1.

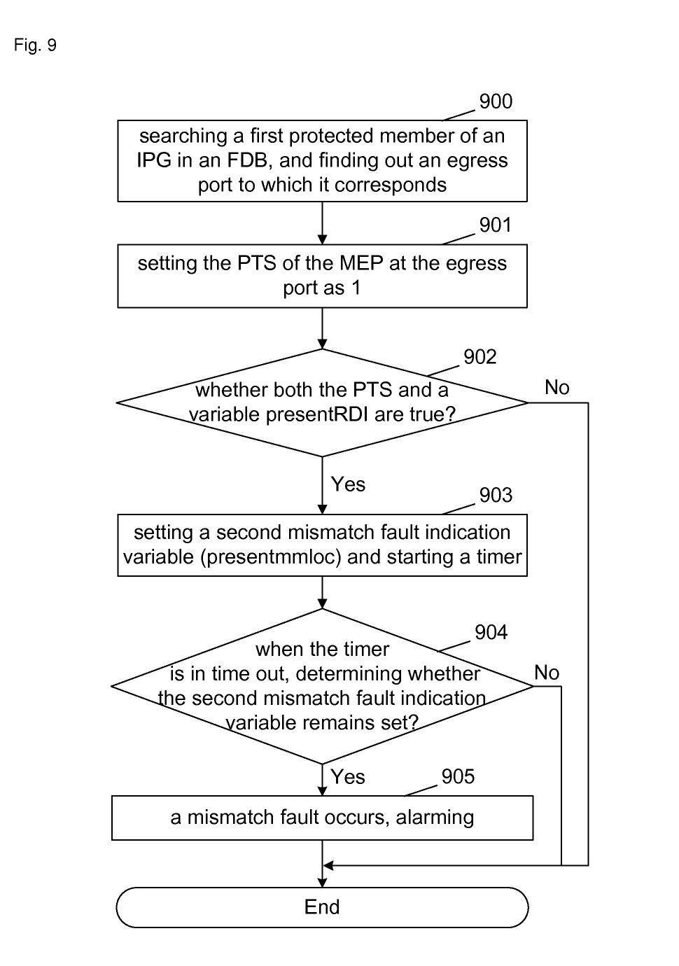

FIG. 9 shows a flowchart of a third embodiment of detecting a mismatch fault according to the disclosure; with reference to FIG. 8, in the third embodiment, supposing that determination of a PTS flag is performed only according to one of the protected members of the IPG, that is, the PTS flag of the MEP in a segment is set if it is detected that there is a member working in the segment, and supposing that an initial value of the PTS flag is 0. As shown in FIG. 9, the embodiment includes the following steps.

Step 900: searching a certain protected member list of an IPG, finding out an item to which either a first protected member or one of the protected members in the list corresponds in an FDB, and finding out an egress port to which it corresponds according to the item.

For the device A, its FDB is shown in FIG. 8, the egress port of the item to which the first protected member<MAC1, VID1> in a certain protected member list of the IPG corresponds in the FDB on the device A is port A2.

Step 901: according to the found egress port, setting the PTS of the MEP where the egress port is.

In the third embodiment, corresponding to the port A2 on the device A, the PTS variable of the MEP at the port A2 is set equal to 1, which means that the traffic is transmitted through the port A2 currently; for the device D, similarly, the PTS variable of the MEP at the port D1 is equal to 1, which means that the traffic is transmitted through the port D1 currently.

Step 902: comparing the value of the PTS variable with the value of a variable presentRDI of the MEP. If both of them are in a set state, or both of them are true, entering step 903; otherwise, operation is normal, and ending the flow;

if the MEP detects that there is fault, it sends the CCM including the set RDI flag, and sets the variable presentRDI of the MEP. Because the MEP sends the CCM with the set RDI flag, it is considered that the opposite end has switched.

In the third embodiment, because a fault occurs in the B-C segment, the device D as endpoint of the IPG can detect the fault; the port D1 of the device D sends the CCM including the RDI flag to the port A1 of the device A, and the variable presentRDI of the MEP at the port D1 is set, that is, the variable presentRDI is equal to 1.

Step 903: setting a second mismatch fault indication variable (presentmmloc), namely, setting it as true or 1; at the same time, starting a timer expiring in a second time period.

For the device D, both the PTS variable and the variable presentRDI of the MEP at its port D1 are set, so the second mismatch fault indication variable (presentmmloc) of the MEP at the port D1 is set.

Step 904: when the timer is in time out, determining whether the second mismatch fault indication variable (presentmmloc) remains set after the second time period expires, if so, entering step 905; otherwise, it is considered that operation is normal, and ending the flow.

Step 905: it is considered that a mismatch fault occurs, alarm information is generated to report the fault.

After the second mismatch fault indication variable (presentmmloc) is set for a while, is it is considered that a mismatch fault occurs on the device D, and alarming to inform the fault.

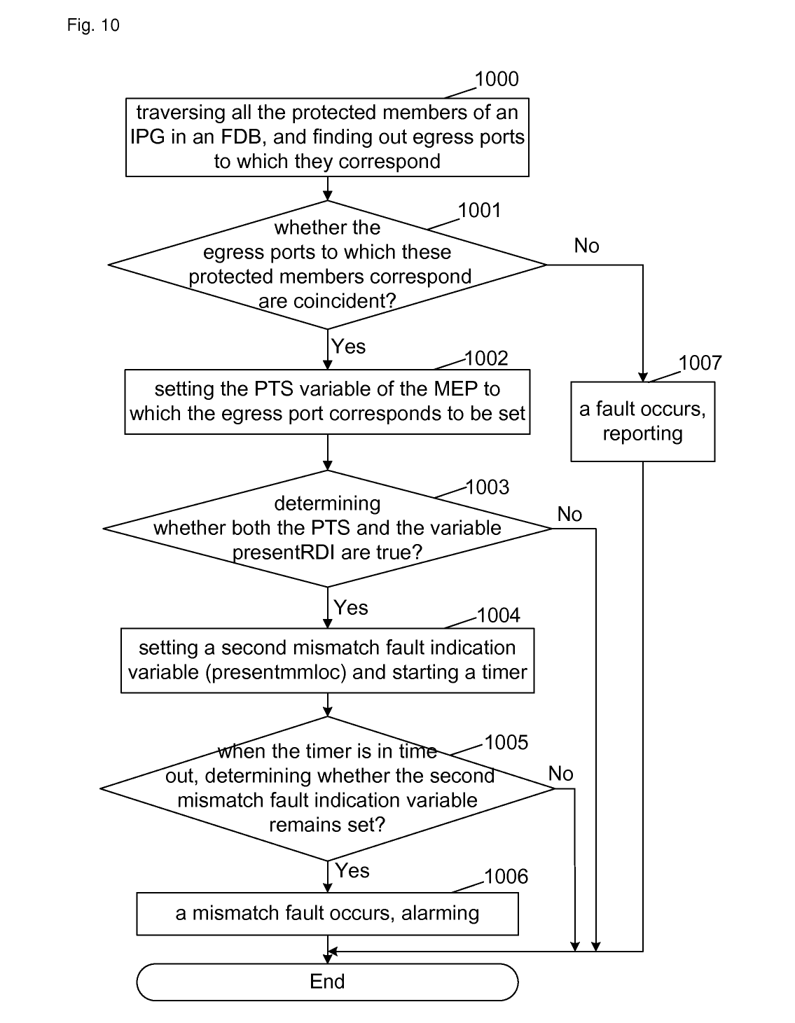

FIG. 10 shows a flowchart of a fourth embodiment of detecting a mismatch fault according to the disclosure; with reference to FIG. 8, in the fourth embodiment, supposing that determination of a PTS flag is performed according to all the protected members of an IPG, that is, it is needed to determine all the protected members; if all the protected members work in a segment, the PTS flag of the MEP in the segment is set, and supposing that an initial value of the PTS flag is 0. As shown in FIG. 10, the embodiment includes the following steps.

Step 1000: searching a certain protected member list of an IPG, traversing all the protected members in the list, searching items to which these protected members correspond in an FDB, and finding out egress ports to which they correspond according to the items.

For the device A, its FDB is shown in FIG. 8; there are two protected members <MAC1, VID1> and <MAC3, VID2> in a certain protected member list of the IPG; it is obtained that both the egress ports of the two protected members are the port A2 by searching corresponding items in the FDB on the device A.

Step 1001: determining whether the egress ports to which these protected members correspond are coincident; if so, entering step 1002; otherwise, entering step 1007.

Step 1002: setting the PTS variable of the MEP to which the egress port corresponds to be set.

Because both the egress ports of two protected members of the IPG on the device A are the port A2, which means that they are coincident, setting the PTS variable of the MEP at the port A2 as 1, which means that the traffic is transmitted through the port A2 currently; similarly, the PTS variable of the MEP at the port D1 on the device D in the fourth embodiment is equal to 1.

Step 1003: comparing the value of the PTS variable with the value of a variable is presentRDI of the MEP. If both of them are in a set state, or both of them are true, entering step 1004; otherwise, operation is normal, and ending the flow;

if the MEP detects that there is fault, it sends the CCM including the RDI flag, and sets the variable presentRDI of the MEP.

In the third embodiment, because a fault occurs in the B-C segment, the device D as endpoint of the IPG can detect the fault; the port D1 of the device D sends the CCM including the RDI flag to the port A1 of the device A, and the variable presentRDI of the MEP at the port D1 is set, that is, the variable presentRDI is equal to 1.

Step 1004: setting a second mismatch fault indication variable (presentmmloc), namely, setting it as true or 1; at the same time, starting a timer expiring in a second time period.

For the device D, both the PTS variable and the variable presentRDI of the MEP at its port D1 are set, so its second mismatch fault indication variable (presentmmloc) is set.

Step 1005: when the timer is in time out, determining whether the second mismatch fault indication variable (presentmmloc) remains set after the second time period expires, if so, entering step 1006; otherwise, it is considered that operation is normal, and ending the flow.

Step 1006: it is considered that a mismatch fault occurs, alarm information is generated to report the fault.

After the second mismatch fault indication variable (presentmmloc) is set for a while, it is considered that a mismatch fault occurs on the device D, and alarming to inform the fault.

Step 1007: reporting related information, and exiting the flow of determining mismatch.

The above is only preferred embodiments of the disclosure and not intended to limit the scope of the claims of the disclosure; any modifications, equivalent replacements, improvements and the like within the spirit and principle of the disclosure shall fall within is the scope of the claims of the disclosure.

What is claimed is:

1. A method for detecting a mismatch fault, comprising:
determining whether there is a Traffic Engineering Service Instance (TESI) configured in a segment, setting a Present Traffic in Segment (PTS) variable, and setting a value of a PTS field included in a Connectivity Check Message (CCM) sent from a Maintenance Endpoint (MEP);
receiving the CCM by the MEP, when the value of the PTS field included in the CCM does not coincide with that of the PTS variable, setting, by the MEP, a first mismatch fault indication variable mmCCMreceived to be set; and
when the first mismatch fault indication variable mmCCMreceived remains set after a first preset time period expires, detecting that a mismatch fault occurs.

2. The method according to claim 1, wherein when determining whether there is a TESI configured in a segment, the setting a PTS variable comprises:
finding out egress port values of the TESI protected by an Infrastructure Protection Group (IPG) in a Forwarding Database (FDB); and setting the PTS variable of the MEP to which the egress port corresponds in the IPG as true or 1.

3. The method according to claim 1, wherein the value of the PTS field included in the CCM is: setting the value of the PTS field (traffic) in the CCM according to a value of the PTS variable of the MEP.

4. The method according to claim 3, wherein the value of the PTS field of the CCM is equal to the value of the PTS variable of the MEP.

5. The method according to claim 2, further comprising: when the MEP detects that a fault occurs in the segment where the MEP itself is,
sending, by the MEP, a CCM including a Remote Defect Indication (RDI) flag, and setting a value of an RDI variable presentRDI of the MEP as true;
when both the value of the variable presentRDI and the value of the PTS variable are true, setting, by the MEP, a second mismatch fault indication variable presentmmloc to be set; and
when the second mismatch fault indication variable presentmmloc remains set after a second preset time period expires, detecting that a mismatch fault occurs; otherwise, detecting that operation is normal and no mismatch fault occurs.

6. The method according to claim 1, wherein the TESI is a TESI traffic or a TESI tunnel protected by the IPG where the MEP is.

7. A method for detecting a mismatch fault, comprising:
determining whether there is a Traffic Engineering Service Instance (TESI) configured in a segment, setting a Present Traffic in Segment (PTS) variable;
when a Maintenance Endpoint (MEP) detects that a fault occurs in the segment where the MEP itself is,
setting, by the MEP, a value of a Remote Defect Indication (RDI) variable presentRDI as true;
when both the value of the variable presentRDI and a value of the PTS variable are true, setting, by the MEP, a second mismatch fault indication variable presentmmloc to be set; and
when the second mismatch fault indication variable presentmmloc remains set after a second preset time period expires, detecting that a mismatch fault occurs.

8. The method according to claim 7, wherein when determining whether there is a TESI configured in a segment, the setting a PTS variable comprises: finding out egress port values of the TESI protected by an Infrastructure Protection Group (IPG) in a Forwarding Database (FDB); and setting the PTS variable of the MEP to which the egress port corresponds in the IPG as true or 1.

9. The method according to claim 7, wherein the setting a value of an RDI variable presentRDI by the MEP comprises: when detecting that a fault occurs in the segment, sending, by the MEP, a Connectivity Check Message (CCM) including an RDI flag which is set, and setting the value of the RDI variable presentRDI of the MEP as true.

10. The method according to claim 7, wherein the TESI is a TESI traffic or a TESI tunnel protected by the IPG where the MEP is.

11. A Maintenance Endpoint (MEP), comprising: the MEP is configured to determine that there is a Traffic Engineering Service Instance (TESI) configured in a segment to which itself corresponds, and set a value of a Present Traffic in Segment (PTS) variable of the MEP itself as true; to include a value of a PTS field in a Connectivity Check Message (CCM) sent from the MEP itself according to the value of the PTS variable; for the MEP which receives the CCM, when the value of the PTS field included in the received CCM does not coincide with that of the PTS variable set by itself, to set a first mismatch fault indication variable mmCCMreceived to be set; and
when the first mismatch fault indication variable mmCCMreceived remains set after a first preset time period expires, the MEP is configured to detect that a mismatch fault occurs.

12. The MEP according to claim 11, wherein the determining that there is a TESI configured in a segment to which the MEP itself corresponds and setting a PTS variable comprises:
an Infrastructure Protection Group (IPG) finds out egress port values of the TESI protected by itself in the a Forwarding Database (FDB); and setting the PTS variable of the MEP to which the egress port corresponds in the IPG as true or 1.

13. The MEP according to claim 11, wherein the MEP is further configured to, when detecting that a fault occurs in the segment where the MEP itself is, send a CCM including a Remote Defect Indication (RDI) flag, and set a value of a variable presentRDI of the current MEP as true.

14. The MEP according to claim 13, wherein the MEP is further configured to, when both the value of the variable presentRDI and the value of the PTS variable are true, set a second mismatch fault indication variable presentmmloc to be set; and
when the second mismatch fault indication variable presentmmloc remains set after a second preset time period expires, it is configured to detect that a mismatch fault occurs; otherwise, it is configured to detect that operation is normal and no mismatch fault occurs.

15. The method according to claim 11, wherein the TESI is a TESI traffic or a TESI tunnel protected by the IPG where the MEP is.

16. A Maintenance Endpoint (MEP), comprising: the MEP is configured to determine that there is a Traffic Engineering Service Instance (TESI) mapped in a segment to which itself corresponds, and set a value of a Present Traffic in Segment (PTS) variable of the MEP itself as true; and to include a value of a PTS field in a Connectivity Check Message (CCM) sent from the MEP itself according to the value of the PTS variable;
when detecting that a fault occurs in the segment where the MEP itself is, the MEP is configured to send a CCM including a Remote Defect Indication (RDI) flag, and set the value of a variable presentRDI of the current MEP as true, which means that a fault of working segment is detected currently;
when both the value of its variable presentRDI and the value of the PTS variable set by itself are true, it is configured to set a second mismatch fault indication variable presentmmlo) to be set; and
when the second mismatch fault indication variable presentmmloc remains set after a second preset time period expires, it is configured to detect that a mismatch fault occurs; otherwise, it is configured to detect that operation is normal and no mismatch fault occurs.

17. The method according to claim 3, further comprising: when the MEP detects that a fault occurs in the segment where the MEP itself is,
sending, by the MEP, a CCM including a Remote Defect Indication (RDI) flag, and setting a value of an RDI variable presentRDI of the MEP as true;
when both the value of the variable presentRDI and the value of the PTS variable are true, setting, by the MEP, a second mismatch fault indication variable presentmmloc to be set; and
when the second mismatch fault indication variable presentmmloc remains set after a second preset time period expires, detecting that a mismatch fault occurs; otherwise, detecting that operation is normal and no mismatch fault occurs.

18. The method according to claim 4, further comprising: when the MEP detects that a fault occurs in the segment where the MEP itself is,
sending, by the MEP, a CCM including a Remote Defect Indication (RDI) flag, and setting a value of an RDI variable presentRDI of the MEP as true;
when both the value of the variable presentRDI and the value of the PTS variable are true, setting, by the MEP, a second mismatch fault indication variable presentmmloc to be set; and
when the second mismatch fault indication variable presentmmloc remains set after a second preset time period expires, detecting that a mismatch fault occurs; otherwise, detecting that operation is normal and no mismatch fault occurs.

19. The MEP according to claim 12, wherein the MEP is further configured to, when detecting that a fault occurs in the segment where the MEP itself is, send a CCM including a Remote Defect Indication (RDI) flag, and set a value of a variable presentRDI of the current MEP as true.

20. The MEP according to claim 19, wherein the MEP is further configured to, when both the value of the variable presentRDI and the value of the PTS variable are true, set a second mismatch fault indication variable presentmmloc to be set; and
when the second mismatch fault indication variable presentmmloc remains set after a second preset time period expires, it is configured to detect that a mismatch fault occurs; otherwise, it is configured to detect that operation is normal and no mismatch fault occurs.
